(19) United States
(12) Patent Application Publication
(10) Pub. No.: US 2012/0012192 A1
(43) Pub. Date: Jan. 19, 2012

(54) Vent Line Protection Device for Gas Regulator

(75) Inventors: James G. Guba, Doylestown, PA (US); Donald E. Kohart, Holland, PA (US)

(73) Assignee: IMAC Systems Inc., Tullytown, PA (US)

(21) Appl. No.: 12/836,883

(22) Filed: Jul. 15, 2010

(51) Int. Cl. F16K 24/04

(52) U.S. Cl. 137/202

(57) ABSTRACT

A vent line protection device to protect the vent of a gas regulator from a predetermined water level, including a vertically-oriented housing having an upper portion including vent line connection and an atmospheric vent opening, and a lower portion including a water opening, the vent line connection being adapted to connect to the vent of the gas regulator, and a float disposed inside the housing and being movable in a vertical direction within the housing, an upper end of the float including a seal adapted for scaling off the vent line connection, wherein when the water level is lower than the predetermined level, gas can flow through the housing between the vent line connection and the atmospheric vent opening, and wherein when the water level is at or higher than the predetermined level, the vent line connection is scaled off by the seal of the float.

### BACKGROUND

Natural gas pressure regulators for residential and commercial gas service are typically mounted with their vent lines near ground level. Sometimes a regulator is mounted outside, but are often it is mounted in a basement where a leak could quickly lead to a dangerous buildup of combustible gas. A supply pipe provides natural gas from a source, often a utility company, to the regulator, and an outlet pipe provides natural gas at a regulated pressure to a consumer. A common type of gas regulator is a self-regulating diaphragm-type regulator which includes a two-part housing separated by a diaphragm that uses spring loading to actuate a valve back and forth to control the regulated gas pressure. The housing on one side of the diaphragm is vented to atmosphere allowing the diaphragm to move back and forth as the regulated pressure is controlled in response to consumer demand.

In current commercially available natural gas regulators, the regulator vent is usually open to atmosphere. Under normal operation, and normal weather conditions, this is not a problem. However, under extreme weather conditions, such as those that cause flooding, there is a risk that the regulator may be submerged in water and that water will enter into the regulator on one side of the diaphragm, impeding the operation of the regulator and possibly rupturing the diaphragm. The results can be dangerous or even catastrophic, including over-pressuring of natural gas equipment in the consumer facility, as well as fire and explosion due to leaking natural gas. Such incidents occur with frequency in flooded conditions. For example, many natural gas regulators failed in New Orleans due to flooding in the wake of Hurricane Katrina.

Therefore, there is a need to prevent flooding of a natural gas regulator via the vent, while still allowing the regulator to perform its desired function of controlling the pressure of natural gas provided to a consumer.

### SUMMARY

A vent line protection device (which may be alternately referred to herein as a “VLP” device) is provided to protect a vent of a gas regulator from flooding when a level of water external to the regulator is at or higher than a predetermined level. The device includes a generally cylindrical vertically-oriented housing and a generally cylindrical float disposed inside the housing and being movable in a vertical direction within the housing. The housing has an upper portion including a vent line connection and a plurality of atmospheric vent openings circumferentially spaced apart about the housing. The housing also has a lower portion including a water opening. An optional U-shaped tube may connect the housing vent line connection to the gas regulator vent, the U-bend of the U-shaped tube being located vertically above the housing vent line connection and the gas regulator vent. Water entering the housing through the water opening causes the float to rise in the housing. Water exiting the housing through the water opening, combined with gravity acting on the float itself, causes the float to lower. An upper end of the float includes a seal adapted for sealing off the vent line connection. A float stand is mounted to the housing for supporting the float above the water opening. When the water level is lower than the predetermined level, the float is positioned such that gas (including air and/or natural gas) can flow through the housing between the vent line connection and the atmospheric vent opening. When the water level is at or higher than the predetermined level, the float is positioned such that the vent line connection is scaled off by the seal of the float.

A vent line protection device is provided to protect a vent of a gas regulator from a level of water external to the regulator at or higher than a predetermined level. The device includes a vertically-oriented housing having an upper portion including vent line connection and an atmospheric vent opening, and a lower portion including a water opening. The vent line connection is adapted to connect to the vent of the gas regulator. The device further includes a float disposed inside the housing and being movable in a vertical direction within the housing by water entering the water opening. An upper end of the float includes a seal adapted for sealing off the vent line connection. When the water level is lower than the predetermined level, gas (including air and/or natural gas) can flow through the housing between the vent line connection and the atmospheric vent opening. When the water level is at or higher than the predetermined level, the vent line connection is sealed off by the seal of the float.

### BRIEF DESCRIPTION OF THE DRAWINGS

The above and other aspects, features and advantages of the vent line protection device described herein will be more apparent from the following more particular description thereof, presented in conjunction with the following drawings wherein:

FIG. 1 is a schematic showing a vent line protection device attached to a gas regulator, with no water present.

FIG. 2 is a schematic showing a vent line protection device attached to a gas regulator, with water lifting up the float in the housing toward vent line connection.

FIG. 3 is a schematic showing a vent line protection device attached to a gas regulator, with water lifting up the float so that an outer seal seals off the vent line connection.

FIG. 4 is a schematic showing a vent line protection device attached to a gas regulator, with water lifting up the float so that an outer seal is compressed and both the outer seal and an inner seal seal off the vent line connection.

FIG. 5 is a cross-sectional view showing a vent line protection device attached to a vent tube, with the float in a closed position.

FIG. 6 is a cross-sectional view showing a vent line protection device attached to a vent tube, with the float in an open position.

FIG. 7 is a cross-sectional view showing a housing for a float in a vent line protection device.

FIG. 8 is a cross-sectional view of the housing of FIG. 7 taken through section line 8-8.

FIG. 9 is a cross-sectional viewing showing a float for use in a vent line protection device.

### DETAILED DESCRIPTION

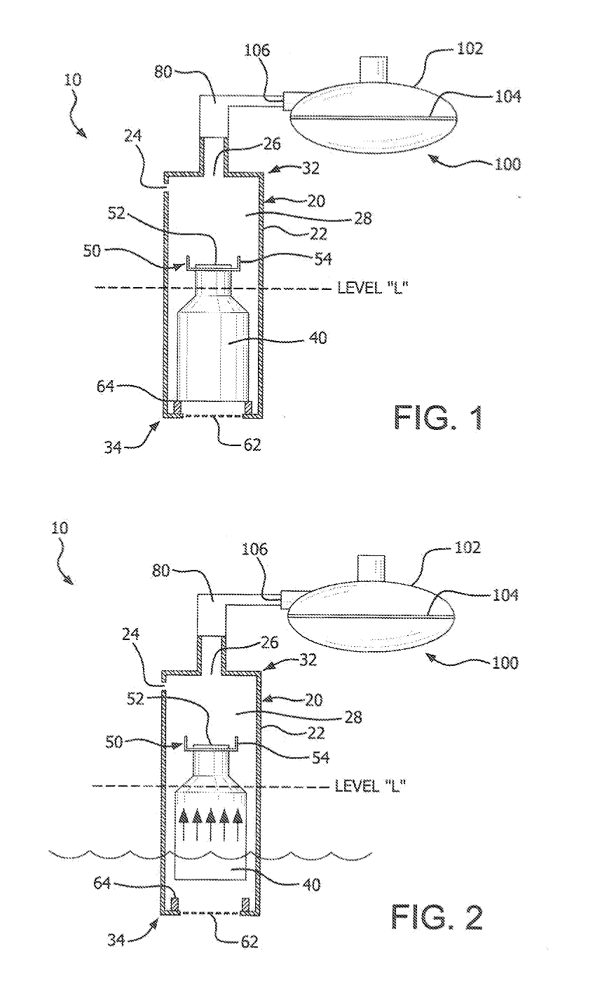

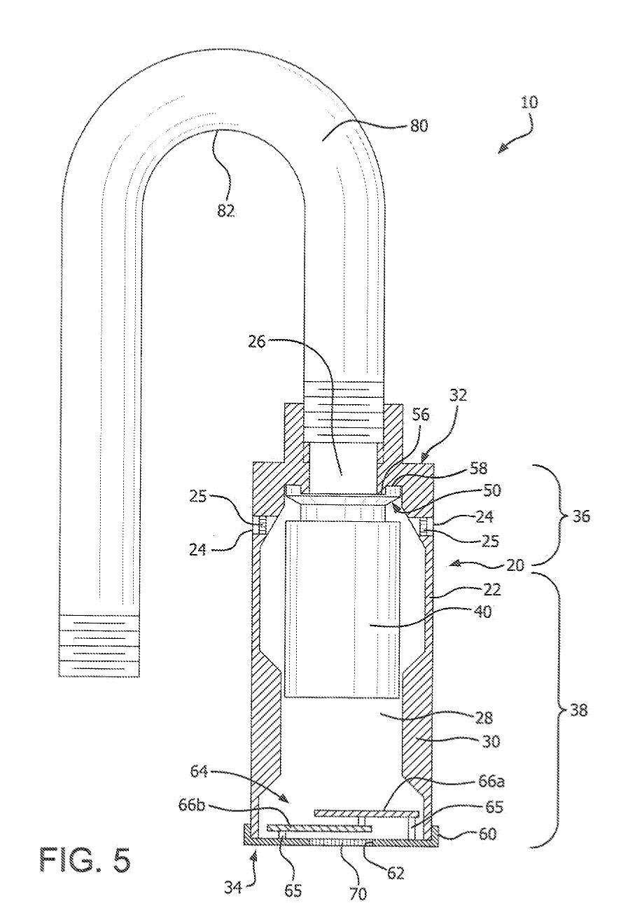

An embodiment of a vent line protection device 10 is shown in FIG. 1 connected to a natural gas pressure regulator 100 by a vent line 80. The regulator 100 can be a standard self-regulating diaphragm-type pressure regulator, such as for residential or commercial use, which typically has a regulator housing 102 and includes a diaphragm 104. The housing 102 on one side of the diaphragm 104 is vented by way of a regulator vent 106 disposed in the housing 102 to allow the housing 102 to breath as the diaphragm 104 moves back and forth to regulate the natural gas pressure supplied to a user. The vent line 80 is connected to the regulator vent 106 to provide a passage for air to flow back and forth between the regulator housing 102 and the outside atmosphere as the regulator 100 controls natural gas pressure based on consumption. The vent line 80 also directs the venting of any natural gas that must be discharged should the diaphragm 104 fail. As used herein, the term “gas” is understood to encompass air, natural gas, and any other gaseous fluid that could be present in the housing 102 of the regulator 100, including but not limited to other combustible gases that may be substituted for natural gas. The physical structure of the device 10 is described with particular reference to FIGS. 5-9, and stages of operation of the device 10 are depicted in FIGS. 1-4.

The device 10 is designed to prevent water from intruding into the regulator 100 due to a flood, such as may be caused by a hurricane. The device 10 allows for full regulator relief of pressure in the housing 102 above the diaphragm 104 through the vent 106, so that the regulator 100 can operate normally and can be allowed to go into full relief if necessary. The device 10 provides minimal flow restriction and pressure drop when the regulator 100 is in full relief.

As shown in detail in FIGS. 5-8, the device 10 includes a housing 20 having a side wall 22 with a top end 32 and a bottom end 34. In this one embodiment, the side wall 22 has the geometry of a right circular cylinder, it being understood that other geometries, including but not limited to square, hexagonal, and octagonal cylinders, or generally cylindrical with some irregularity can function equally well. In one embodiment, the housing 20 is made from a cast aluminum alloy to resist corrosion and to minimize weight.

As installed, the housing 20 is disposed in a substantially vertical orientation with the top end 32 facing substantially upward and the bottom end 34 facing substantially downward. The substantially vertical orientation of the housing 20 allows the device 10 to operate properly under the effects of gravity and buoyancy. The housing wall 22 encloses a cavity 28 in which a float 40 is allowed to move upward and downward, toward the top end 32 and toward the bottom end 34, respectively, as the water level within the cavity 28 changes.

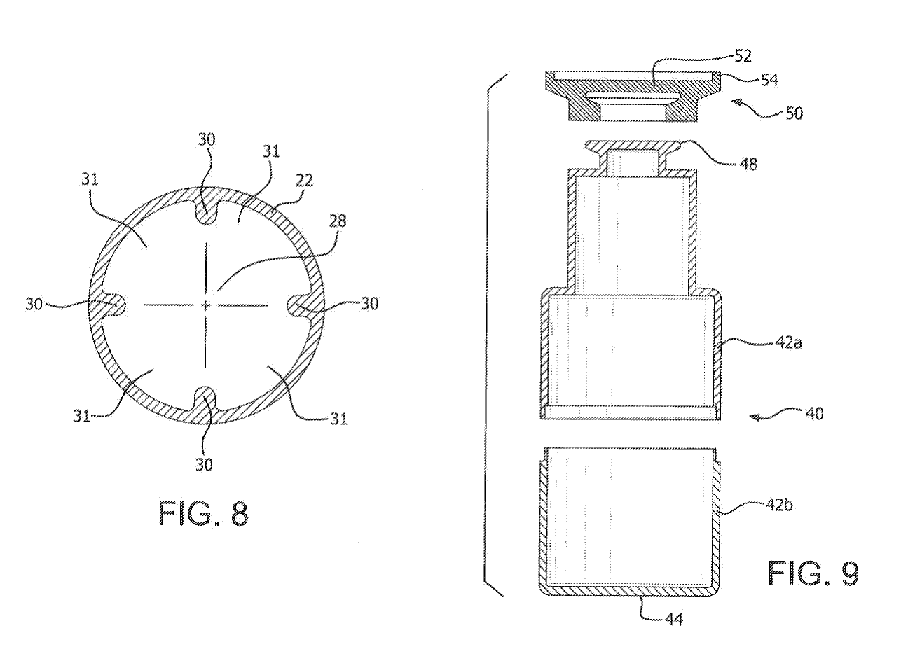

The housing 20 comprises an upper portion 36 and a lower portion 38. A plurality of float guides 30 protrude inwardly into the cavity 28 from the wall 22 in the lower portion 38 of the housing 20, to guide the float 40 and keep the float generally centered within the cavity 28 as the float 40 moves upward and downward. As shown in greater detail in FIGS. 7-8, each float guide 30 includes an elongate protrusion extending substantially vertically along the wall 22 and projecting radially inward therefrom into the cavity 28 in the lower portion 38 of the housing. Spaces 31 between adjacent float guides 30 allow water and/or air to move or flow around the float 40 within the cavity 28, i.e., between the float 40 and the wall 22.

A vent line connection 26 is located at the top end 32 of the housing 20 for connecting to the vent line 80. The vent line connection 26 provides a passage for gas (including air and/or natural gas) communication between the housing cavity 28 and the regulator vent 106. In the embodiment depicted in FIG. 5, the vent line 80 has an inverted U-shape, with a U-bend 82 being located above both the vent line connection 26 and the regulator vent 106. The inverted U-shaped vent line 80 provides a pocket of gas in the U-bend 82 that inhibits water intrusion from the housing cavity 28 and helps prevent any water that may intrude into the vent line 80 from reaching the regulator vent 106. In one embodiment, the height of the U-bend 82 is at least 10 inches above the vent line connection 26.

The upper portion 36 of the housing 20 includes one more atmospheric vent openings 24 to provide a communication path for air to flow between the cavity 28 and the external surroundings of the housing 20. When the vent line connection 26 is open, gas can flow freely from the regulator vent 106 to atmosphere via the vent line 80, the vent line connection 26, the cavity 28, and the vent openings 24. Accordingly, when the water level is below or above the bottom 34 of the housing, the vent openings 24 provide a pathway to allow air to flow through the housing cavity 28 and into or out of the vent line 80 via the vent line connection 26.

The vent openings 24 are located above a predetermined level L on the housing 20 at which rising water causes the float 40 to seal off the vent line connection 26. In one embodiment, four vent openings 24 are provided equally spaced apart around the periphery of the housing wall 22. The vent openings 24 can alternatively be located in an upper end wall of the housing 20. The vent openings 24 may each include a screen 25 to inhibit debris or contaminants from entering the housing through the vent openings 24. Debris is undesirable because it can compromise the seal between a seal 50 at the top of the float 40 and vent line connection 26, and can also impair the upward and downward movement of the float 40 within the housing cavity 28. In one embodiment, a 60-mesh stainless steel screen has been used as the screen 25.

The vent openings 24, in combination with the screens 25, allow for air to exit the upper portion 36 of the housing 20 as the water level rises, and also allow for both water and air to enter the upper portion 36 of the housing 20, above the float 40, as the water level recedes. Water flowing through the vent openings 24 and downward through the housing 20 to the water opening 62 helps the float 40 to release its seal at the vent line connection 26 as the water level recedes. In particular, although in many cases the force of gravity on the float 40 is sufficient to cause the float 40 to drop from the vent line connection 26 as the water level recedes, the soft material of the seal 50 may have a tendency to stick to sealing surfaces 56 and 58. The action of the downwardly flowing water helps to overcome the tendency of the seal 50 to stick.

The lower portion 38 of the housing 20 is capped by a base 60 that includes at least one water opening 62 for allowing water to flow into and out of the cavity 28 from below, as the external water level rises or falls, respectively. The base 60 is removably mounted to the housing wall 22 by a conventional mechanism. The base 60 is installed to the housing wall 22 during normal operation, but can be removed for replacement and maintenance of the float 40, and for cleaning the cavity 28. The water opening 62 may include a screen 70 to inhibit debris or contaminants from entering the housing through the water opening 62. In one embodiment, a 40-mesh stainless steel screen has been used as the screen 70.

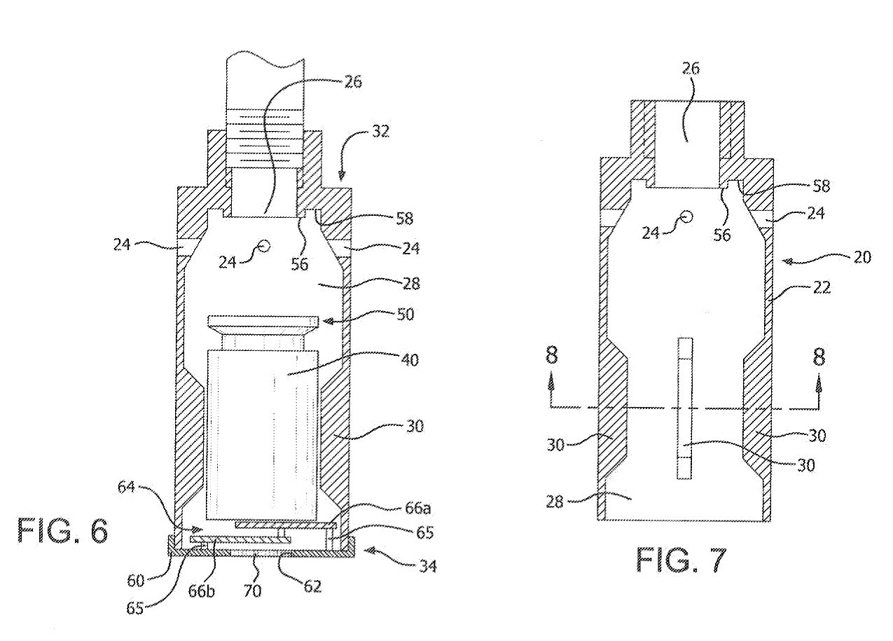

The base 60 includes a float stand 64 for maintaining the float 40 above the bottom 34 of the housing and away from the water opening 62 in the base 60. The float stand 64 includes a plurality of legs 65 supporting one or more baffles 66. The baffles 66 slow the flow of water into the housing cavity 28 and are effective at trapping or catching any debris that enters the water opening 62. In the embodiment depicted in FIGS. 5 and 6, the float stand 64 includes two baffles 66a, 66b offset from each other by the legs 65 in both the lateral and the vertical directions to create a tortuous path for water entering the cavity 28 from the water opening 62. Any number of baffles 66 may be used. As shown, the baffles 66a, 66b each have a curved edge conforming to the shape of the housing wall 22 and a straight edge around which water can flow, but innumerable baffles shapes can be created to accomplish the desired purpose. Alternatively, larger mesh screens can be used in place of, or in combination with, baffles.

Testing was performed in an embodiment including a screen 70 across the water opening 62 in combination with a float stand 64 having two staggered baffles 66a, 66b, as shown. This combination of components was found to be extremely effective at trapping debris that could otherwise impair operation of the float 40 and the sealing off of the vent line connection 26.

The float 40 is constructed to have a specific gravity of less than 1, so that it is buoyant or floatable in water. In the embodiment shown in FIG. 9, the float 40 is hollow and includes a shell 42 enclosing a cavity 46. In one embodiment, the float shell 42 can be made from an upper half 42a and a lower half 42b bonded together in a watertight seal. The float has a bottom end 44 and a top end 48. The seal 50 is located at the top end 48. In one embodiment, the float 40 is made from a molded polyethylene material (such as ultra high molecular weight polyethylene, UHMWPE) which is durable, abrasion resistant, and self-lubricating.

In one embodiment, the float 40 is generally cylindrical in shape, it being understood that a float 40 of another symmetric geometry, including square, hexagonal, and octagonal, could function equally well in the device 10, including when the cavity 28 in the housing 20 is generally cylindrical, square, hexagonal, or octagonal. The location and number of float guides 30 are selected to correspond to the geometry of the float 40 and the geometry of the housing wall 22. In non-limiting examples, three float guides 30 equally spaced around the internal circumference of the cavity 28 can guide a round or hexagonal float 40, and four equally-spaced float guides 30 can guide a round, square, or octagonal float 40.

The seal 50 at the top end 48 of the float 40 includes an inner seal 52 and an outer seal 54 surrounding the inner seal 52 and extending upwardly with respect to the inner seal 52. In one embodiment, as depicted in FIG. 8, the seal 50 is in the form of a boot that is made removable from the top end 48 of the float 40 to facilitate maintenance and replacement. In one embodiment, the seal 50 is made from a fluorosilicone material that is both durable and resilient. The flexible material of the seal 50 enables the inner seal 52 to form a positive seal and also enables the outer seal 54 to flex as the float 40 moves upward and the seal 50 begins to contact the housing 20 surrounding the vent line opening 26.

An annular raised sealing surface 56 is located in the upper portion 36 of the housing 20 surrounding the vent line opening 26, and an annular recessed sealing surface 58 surrounds the raised sealing surface 56. As the float 40 rises in the cavity 28, buoyed by water entering through the water opening 62 in the base 60, the movement of the float 40 is unencumbered until the float 40 encounters resistance as the outer seal 54 contacts and begins to seal with the recessed sealing surface 58. As the float 40 continues to rise slightly, the outer seal 54 is compressed until the inner seal 52 contacts and begins to seal with the raised sealing surface 56. In operation of the device 10, the inner seal 52 provides a leak-free seal when the float 40 is pressed up against the raised sealing surface 56 surrounding the vent line connection 26, while the outer seal 54 helps to center the float 40 and provides a backup seal against the recessed sealing surface 58.

When gas pressure accumulates in the vent tube 80, the float 40 may be pushed slightly downward, lifting the inner seal 52 out of contact with the raised sealing surface 56. In this circumstance, the outer seal 54 maintains a leak-free seal while allowing gas to escape from the vent tube 80. One or more gas bubbles can exit the vent tube 80 through the vent line connection 26 by squeezing between the outer seal 54 and the recessed sealing surface 58, while the outer seal 54 substantially prevents water from entering through the vent line connection 26 into the vent tube 80. The exiting of a gas bubble relieves excess pressure above the float 40 and allows the float 40 to move upward almost instantaneously once gas pressure is relieved, such that by the time the outer seal 54 is flexing to allow a gas bubble to escape, the buoyancy of the float 40 almost immediately returns the inner seal 52 into contact with the raised sealing surface 56.

FIGS. 1-4 depict schematics of the device 10 at various stages of operation, and FIG. 5 depicts an enlarged view of the device 10. In FIG. 1, the device 10 is shown in a normal, non-flooded operating state. In this state, the water level external to the housing 20 is below the bottom 34 of the housing (and is typically zero), well below the predetermined level L at which the seal 50 first begins to seal off the vent line connection 26. The level L is indicated in the figures as the threshold external water level that will cause the float 40 to rise enough to cause the outer seal 54 to initiate a seal with the recessed sealing surface 58. In non-flooded use of the device 10, the float 40 is at rest on the float stand 64 of the base 60 under the force of gravity. The vent line opening 26 is open so that gas can freely flow to and from the regulator vent 106 via the vent tube 80 and into and through the cavity 28 via the vent line opening 26 and the atmospheric vent openings 24.

In FIG. 2, the device 10 is shown in a state in which the water level is rising but is below the level L required to make an initial seal. Because the float 40 is hollow, it is buoyant in water. The float 40 may also be made from a material having a specific gravity less than 1, making it further buoyant in water. The rising water level lifts the float 40 off the float stand 64 but is not sufficient to lift the float high enough for the seal 50 to seal off the vent line connection 26.

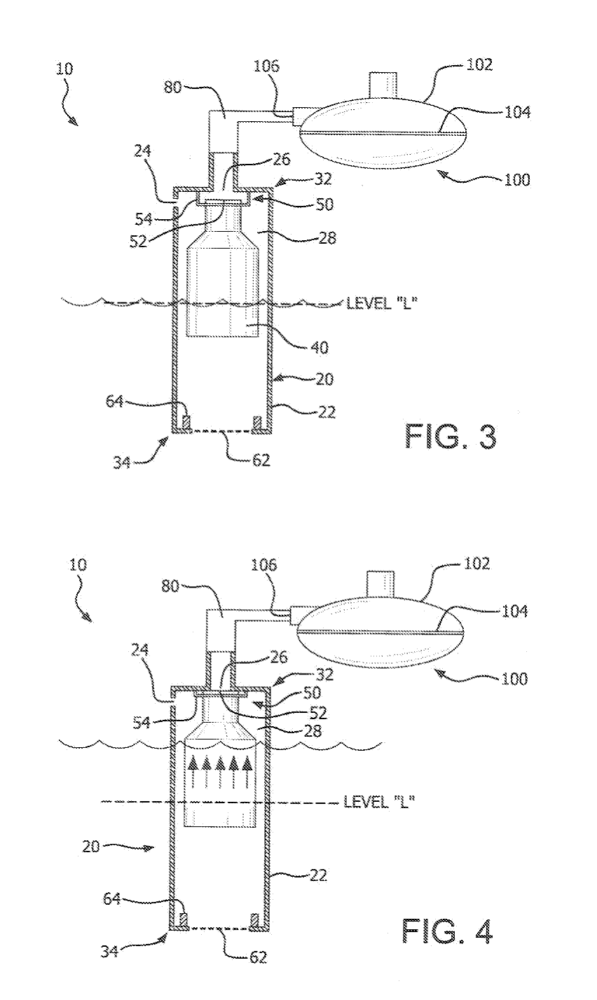

In FIG. 3, the device 10 is shown in a state in which the water level has risen to be approximately equal to the level L required to make an initial seal. At this water level, the outer seal 54 contacts the recessed sealing surface 58 to seal off the vent line connection 26, but the inner seal 52 has not yet contacted the raised sealing surface 56. The combination of the outer seal 54 and the recessed sealing surface 58 serves to center and align the seal 50 about the vent line connection 26, while the float guides 30 continue to keep the float 40 centered in the cavity 28. If gas pressure (e.g., the pressure of air and/or natural gas) increases in the vent line 80 such that gas needs to escape from the vent line 80, the excess pressure causes the outer seal 54 to flex slightly until the gas forces its way out between the outer seal 54 and the recessed sealing surface 58, at which point the outer seal 54 immediately returns to contact with the recessed sealing surface 58 to reestablish the seal.

In FIG. 4, the device 10 is shown in a state in which the water level has risen to be above the level L required to make an initial seal. Such a level can include a situation in which the device 10, including the atmospheric vent openings 24, is completely submerged. At this water level, the float 40 has risen to compress the outer seal 54 against the recessed sealing surface 58 and to force the inner seal 52 into sealing contact with the raised sealing surface 56. The interface between the inner seal 52 and the raised sealing surface 56, which is backed up by the interface between the outer seal 54 and the recessed sealing surface 58, creates a positive seal sufficient to prevent water intrusion into the vent line 80 even under completely flooded conditions when the entire device 10 is submerged in water. Indeed, as the water level rises higher, the sealing pressure between the inner seal 52 and the raised sealing surface 56 increases.

In the flooded condition, if gas pressure increases in the vent line 80 such that gas needs to escape from the vent line 80, the gas pressure increases until it balances the buoyancy force imposed on the seal 50 by the float 40. The inner seal 52 is forced slightly away from the raised sealing surface 56, and then the excess pressure causes the outer seal 54 to flex slightly so that one or more gas bubbles can slip out between the outer seal 54 and the recessed sealing surface 58. Almost immediately, the release of the excess gas pressure causes the outer seal 54 to return to contact with the recessed sealing surface 58, reestablishing the sealing off of the vent line connection 26, and the float 40 is buoyed upward so that the inner seal 52 reestablishes sealing contact with the raised sealing surface 56. Consequently, no water, or at most an inconsequential amount of water, is able to get past the outer seal 54 into the space between the outer seal 54 and the inner seal 52, or into the vent line connection 26.

Any gas bubbles escaping into the upper portion 36 of the housing can be vented via the atmospheric vent openings 24, even if the openings 24 are submerged. If the atmospheric vent openings 24 are somewhat below the top 32 of the housing 20 a small amount of vented gas will accumulate in the housing 20 before being released.

When the water level recedes, the device 10 continues to allow the gas regulator 100 to operate normally. In particular, when the water level decreases from higher than the level L to lower than the level L, the float 40 drops with the water level. The inner seal 52 first breaks contact with the raised sealing surface 56 and the outer seal 54 then breaks contact with the recessed sealing surface 58, thus opening the vent line opening 26 and exposing the vent tube 80 to atmospheric pressure. As the water level continues to recede; the float 40 drops with the water level until the float 40 again rests on the float stand 64.

An exemplary embodiment of the device 10 has been manufactured and tested for compliance with 49 C.F.R. §192, subpart H, which relates to Transportation of Natural Gas and Other Gases: Customer Meters, Service Regulators, and Service Lines. The testing was done in conformance with the procedures of ANSI B109.4-1998, 5.3.3-5.3.7 and 5.3.12, which applies to self-operated diaphragm-type natural gas service regulators.

The foregoing describes the vent line protection device in terms of embodiments foreseen by the inventors for which an enabling description was available, notwithstanding that insubstantial modifications of the device, not presently foreseen, may nonetheless represent equivalents thereto.

1. A vent line protection device to protect a vent of a gas regulator from a level of water external to the regulator at or higher than a predetermined level, the device comprising:
a vertically-oriented housing having an upper portion including a vent line connection and a plurality of atmospheric vent openings circumferentially spaced apart about the housing, and a lower portion including a water opening;
a float disposed inside the housing and being movable in a vertical direction within the housing, an upper end of the float including a seal adapted for sealing off the vent line connection; and
a float stand for supporting the float above the water opening;
wherein when the water level is lower than the predetermined level, the float is positioned such that gas can flow through the housing between the vent line connection and the atmospheric vent openings; and
wherein when the water level is at or higher than the predetermined level, the float is positioned such that the vent line connection is sealed off by the seal of the float.

2. The vent line protection device of claim 1, the seal including an inner seal surrounded by an outer seal;
wherein the outer seal forms a seal around the vent line connection at the predetermined water level and allows gas to escape from the vent line connection into the housing while substantially preventing water intrusion into the vent line connection; and
wherein the inner seal forms a seal around the vent line connection at a water level slightly higher than the predetermined water level and maintains a positive seal until gas pressure above the inner seal exceeds buoyant force on the inner seal imposed by the float.

3. The vent line protection device of claim 2, the housing including an annular recessed sealing surface surrounding the vent line connection to mate with the outer seal.

4. The vent line protection device of claim 3, the housing further including an annular raised sealing surface between the vent line connection and the recessed sealing surface to mate with the inner seal.

5. The vent line protection device of claim 1, further comprising:
a screen protecting each atmospheric vent opening to inhibit debris from entering the housing; and
a screen in combination with one or more baffle plates disposed in the lower portion of the housing between the float and the water opening to further inhibit debris in the water from entering the housing.

6. The vent line protection device of claim 1, further comprising:
a U-shaped tube connecting the vent line connection to the gas regulator vent and having a U-bend located vertically above the housing vent line connection and the gas regulator vent;

7. A vent line protection device to protect the vent of a gas regulator from a level of water external to the regulator at or higher than a predetermined level, the device comprising:
a vertically-oriented housing having an upper portion including vent line connection and an atmospheric vent opening, and a lower portion including a water opening, the vent line connection being adapted to connect to the vent of the gas regulator; and
a float disposed inside the housing and being movable in a vertical direction within the housing, an upper end of the float including a seal adapted for scaling off the vent line connection;
wherein when the water level is lower than the predetermined level, gas can flow through the housing between the vent line connection and the atmospheric vent opening; and
wherein when the water level is at or higher than the predetermined level, the vent line connection is sealed off by the seal of the float.

8. The vent line protection device of claim 7, the seal including an outer seal that forms a seal around the vent line connection at the predetermined water level allows gas to escape from the vent line connection into the housing when the gas pressure at the vent line connection exceeds the buoyant force on the seal imposed by the float, while substantially preventing water intrusion into the vent line connection.

9. The vent line protection device of claim 8, the housing including an annular recessed sealing surface surrounding the vent line connection to mate with the outer seal.

10. The vent line protection device of claim 8, the seal further including an inner seal that forms a seal around the vent line connection at a water level slightly higher than the predetermined water level, the inner seal being surrounded by the outer seal;
wherein the inner seal maintains a positive seal until gas pressure above the inner seal exceeds the buoyant force on the seal imposed by the float.

11. The vent line protection device of claim 10, the housing including an annular raised sealing surface surrounding the vent line connection to mate with the inner seal.

12. The vent line protection device of claim 7, wherein the atmospheric vent opening includes a screen for inhibiting debris from entering the housing.

13. The vent line protection device of claim 7, wherein a removable base is mounted to the housing to enable removing the float from the housing.

14. The vent line protection device of claim 7, the upper portion of the housing comprising at least two atmospheric vent openings.

15. The vent line protection device of claim 7, wherein the housing and the float each have a generally cylindrical cross-section.

16. The vent line protection device of claim 7, wherein the water opening includes a screen for inhibiting debris in the water from entering the housing.

17. The vent line protection device of claim 16, further comprising at least one baffle plate disposed in the lower portion of the housing between the float and the water opening for inhibiting debris in the water from entering the housing.

18. The vent line protection device of claim 7, further comprising a U-shaped tube connecting the housing vent line connection to the gas regulator vent and having a U-bend located vertically above the housing vent line connection and the gas regulator vent.
